(19) United States
(12) Patent Application Publication
(10) Pub. No.: US 2021/0331413 A1
(43) Pub. Date: Oct. 28, 2021

(54) CONTROLLING ENERGY SOURCE IN THREE-DIMENSIONAL PRINTING

(71) Applicant: HEWLETT-PACKARD DEVELOPMENT COMPANY, L.P., Spring, TX (US)

(72) Inventor: Arthur H. Barnes, Vancouver, WA (US)

(21) Appl. No.: 16/608,236

(22) PCT Filed: Jun. 18, 2018
(86) PCT No.: PCT/US2018/038020

§ 371 Date: Oct. 25, 2019

(51) Int. Cl. B29C 64/393; B29C 64/232; B29C 64/268; B29C 64/153; B33Y 10/00; B33Y 30/00; B33Y 50/02

(52) U.S. Cl. CPC B29C 64/393; B29C 64/232; B29C 64/268; B33Y 50/02; B33Y 10/00; B33Y 30/00; B29C 64/153

(57) ABSTRACT

According to one example there is provided a method of controlling an energy source in a 3D printing system. The method comprises instructing a build platform drive module to lower the build platform by an amount, forming a layer of build material on the build platform, determining the actual amount by which the build platform was lowered, controlling the energy source to emit an amount of energy based on the determined actual amount by which the build platform was lowered.

### BACKGROUND

Some three-dimensional printing systems generate 3D objects by selectively solidifying successive layers of a build material formed on a movable build platform. Some such systems, for example, selectively apply, or print, an energy absorbent fusing agent onto a formed layer of build material based on a 3D object model of the object to be generated. Energy is then applied, from a suitable energy source, to the layer of build material which causes those portions of the build material layer on which fusing agent was applied to heat up sufficiently to melt, sinter, or otherwise fuse together, thereby forming a layer of a 3D object being generated. The wavelengths of energy absorbed by the fusing agent may be generally matched to the wavelengths emitted by the energy source.

Other 3D printing techniques include so-called binder jet systems which selectively print a binder agent onto layers of build material to selectively bind portions of the layer to form a layer of the object being generated. Such systems may use thermal or ultra-violet energy to cure or activate a binder agent.

Typically, during processing of a 3D print job, each formed layer of build material may have the same thickness. For 3D printing processes aiming to generate objects having high quality and high dimensional accuracy, the layer thickness may be selected, for example, from a range of about 50 to 120 microns.

### BRIEF DESCRIPTION

Examples will now be described, by way of non-limiting example only, with reference to the accompanying drawings, in which:

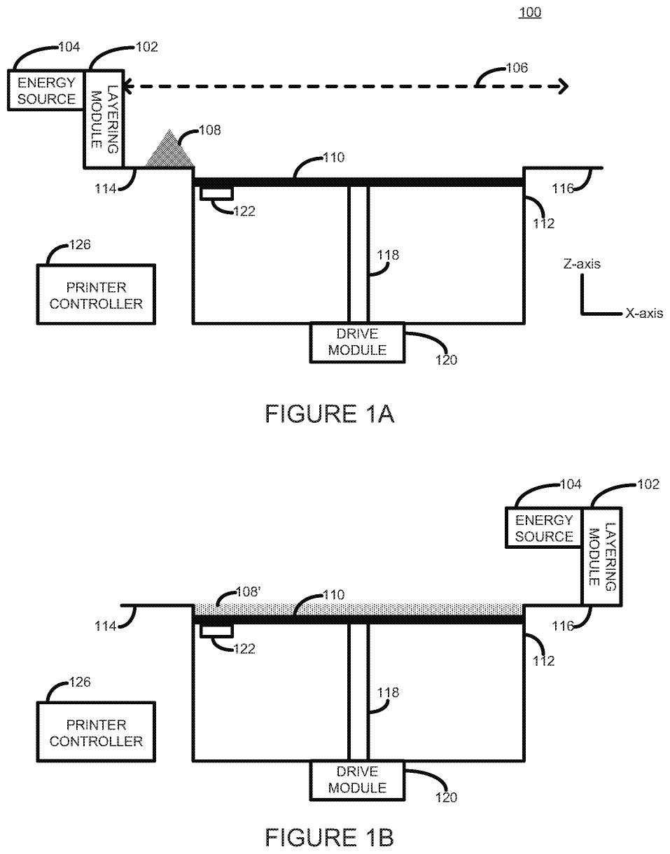

FIGS. 1A and 1B are simplified side view illustrations of a 3D printing system according to one example;

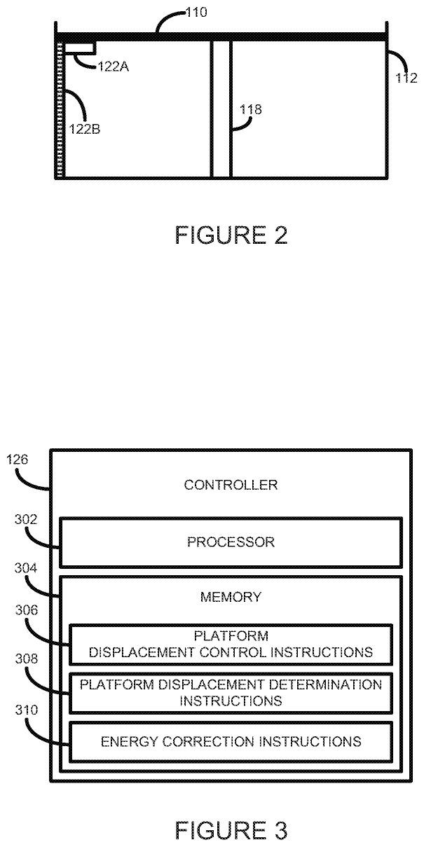

FIG. 2 is an illustration of a measurement module according to one example;

FIG. 3 is a block diagram of a 3D printer controller according to one example;

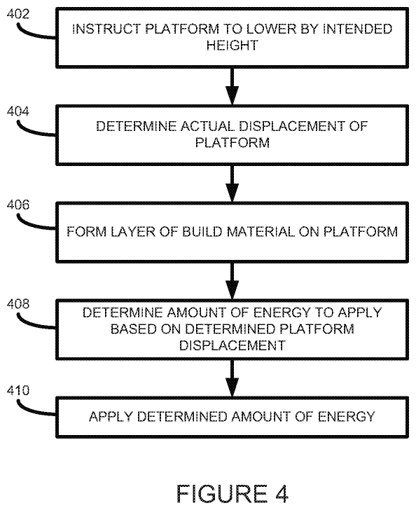

FIG. 4 is a flow diagram outlining an example method of controlling a 3D printing system according to one example;

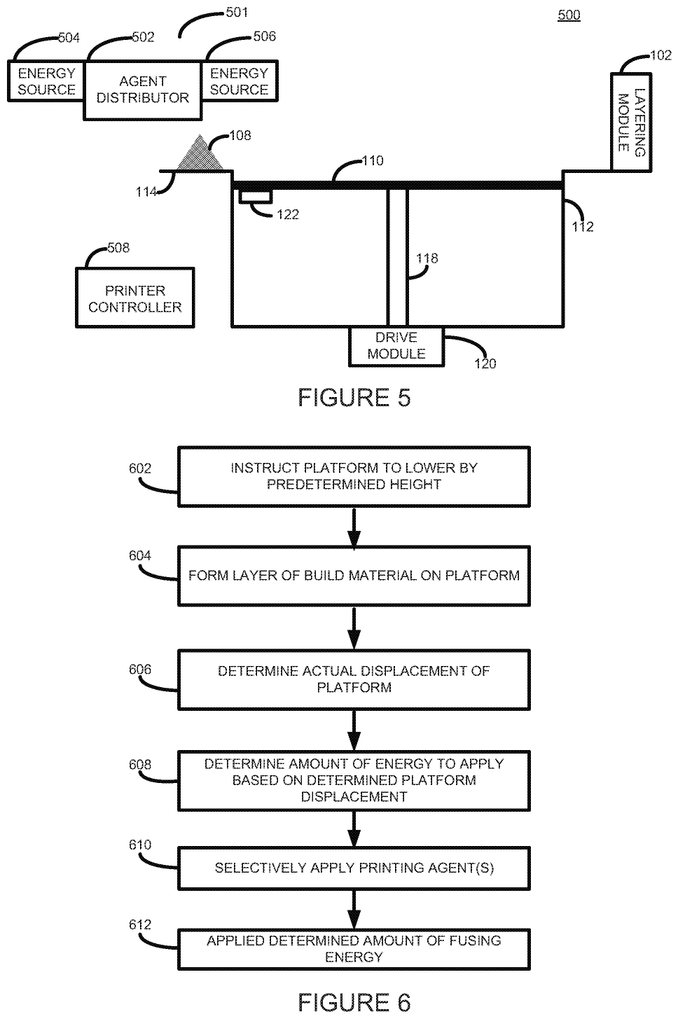

FIG. 5 is a simplified side view illustration of a 3D printing system according to one example;

FIG. 6 is a flow diagram outlining an example method of controlling a 3D printing system according to one example; and

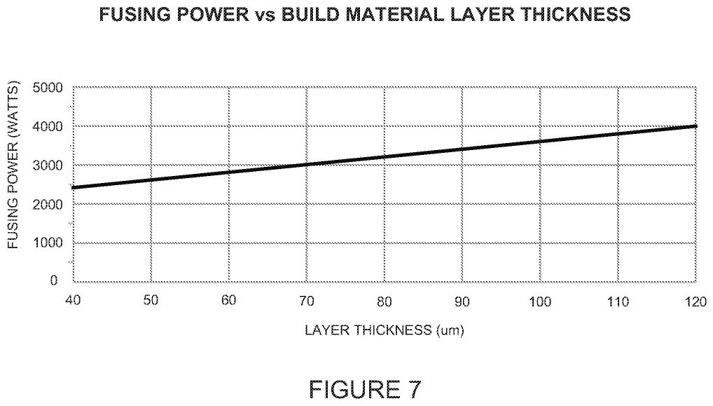

FIG. 7 is a graph showing the relationship between fusing power and actual layer thickness according to one example.

### DETAILED DESCRIPTION

The thickness of a formed layer of build material is generally dictated by the distance between the base of a build material recoater element, and the surface, typically the top surface, of a build platform on which layers of build material are to be formed. A first layer of build material may be formed directly on the build platform, and subsequent layers may be formed on a previously formed layer.

In 3D printing systems that apply energy to a layer of build material to cause selective fusing thereof, the amount of energy to be applied is generally fixed for a 3D printing process, based on the intended thickness of the layers to be formed from which the 3D object is to be generated.

It has been observed that, although it may be intended that the thickness of successive layers of build material be constant during the generation of an object, the actual thickness of a layer may vary somewhat. The variation between intended layer thickness and actual layer thickness may be based on a number of factors.

For example, if the build platform is moved by rotating a lead screw using a motor, it may be difficult to precisely control the angular rotation of the motor shaft which may lead to the lead screw moving by an amount different from an intended amount. Furthermore, if gears are used to couple a control motor to the lead screw, gear backlash, or ‘play’, may further lead to the build platform moving by an unintended amount.

Powdered build material may also enter the region between the build platform boundary and the walls of a build chamber which may increase the friction of the build platform as it is moved which may lead to non-predictable movement of the build platform.

Consequently, these and other factors may affect the actual thickness of each formed layer.

Examples described herein provide a system and method for determining an actual thickness of a formed layer of build material based on a measured displacement of the build platform. The energy applied to each formed layer is modified, from a base amount based on the intended layer thickness, according to the actual build platform displacement and hence the actual build material layer thickness. In this way, a suitable amount of fusing energy is applied to each layer of build material to ensure an intended degree of fusing of portions of each formed layer. Such a technique thereby helps prevents thicker than intended layers from being under fused, and also prevents thinner than intended layers from being over fused. Under-fused layers may, for example, present weaker inter-layer strength compared to optimally fused layers. Over-fused layers may, for example, cause fusing of build material that was not intended to be fused, for example through thermal bleed between layers and/or through thermal bleed laterally within a layer.

Consequently, using the examples described herein, formed layers of build material which are thicker than intended may receive additional fusing energy, compared to the energy applied to a layer having the intended thickness. Conversely, formed layers which are thinner than intended may receive reduced fusing energy, compared to the energy applied to a layer having the intended thickness.

The term ‘layer thickness’, as used herein, is generally intended to refer to the general thickness of a layer of build material formed on a build platform, or formed on a previously formed layer. The layer thickness will generally be the difference in height between the top surface of the build platform (or the top surface of a previously formed layer of build material) and the base of a build material spreader or recoater. It will be understood, however, that the thickness of a layer of build material formed on a previously formed layer, portions of which have been selectively solidified, may be locally different. This may be because solidified build material may contract, compact, or densify in the vertical axis, and may thus provide a base which is lower than portions of non-solidified build material of the same layer.

Referring now to FIG. 1A there shown a simplified side view of a three-dimensional (3D) printing system 100 according to one example. For clarity, not all elements of a complete 3D printing system are shown.

The example 3D printing system 100 comprises a carriage (not shown) on which is mounted a build material layering module 102, such as a recoater, and an energy source 104. The carriage, and hence the build material layering module 102 and the energy source 104, is moveable bi-directionally along the x-axis, as indicated by arrow 106. The build material layering module 102 is to form a layer of build material on a build platform 110. For example, in one example the build material layering module may be a recoater which is to spread a volume of build material 108, such as a powdered, particulate, or granular type of build material, over a build platform 110 of a build unit 112, as illustrated in FIG. 1B. The build material may be any suitable type of build material, including plastic, metal, and ceramic build materials. A suitable plastic build material may be a PA12 build material commercially known as V1R10A “HP PA12” available from HP Inc.

The build material layering module 102 may be in the form, for example, of a counter-rotating roller, a wiper, or any other suitable spreading mechanism. In one example the build material layering module 102 may be a build material dispersion device that directly forms, for example through overhead deposition, a layer of build material on the build platform 110.

The energy source 104 may be any suitable energy source, such as a halogen lamp that, for example, may be used to apply a generally uniform amount of energy to each layer of build material as the energy source 104 is moved over the build platform 110.

The volume of build material 108 may be formed on a build material supply platform 114 by a build material dosing module (not shown). A suitable dosing module may be a hopper, a moveable vane, or any other suitable build material dosing mechanism. The volume of build material 108 may be formed as a volume of build material having a substantially uniform cross-section along the length of the build material supply platform, i.e. extending along the y-axis perpendicular to plane of the drawing. After spreading, any excess build material may be left on a build material receiving platform 116 from where it may, for example, be reused in a reverse spreading process, or recovered for use in a subsequent operation.

The build platform 110 is coupled to a support element 118 which is coupled to a drive, or control, module 120. In one example the support element 118 comprises a lead screw threaded through a fixed nut (not shown). Rotation of the lead screw by the drive module 120 thus causes the position of the build platform 110 to vary, depending on the direction of rotation of the lead screw. In another example, the support element 118 may be a hydraulic piston, and the drive module 120 may be hydraulic drive system to vary the hydraulic pressure within the piston. In use, the drive module 120 is instructed, or is controlled, to lower the build platform 110 by an intended amount. The intended amount is the predetermined layer thickness that is to be used during a 3D printing build operation. However, as discussed above, the distance by which the build platform 110 may be intended to move may be different from the distance the build platform 110 actually moves.

To enable the vertical displacement of the build platform 110 within the build unit 112 to be accurately determined a measurement module 122 is provided. In one example, ‘accurately determine’ may be understood to mean accurate to within about 5%, to within about 10%, or within about 20%, or within about 30% of the intended thickness of a layer of build material being formed. For example, if the intended layer thickness is about 80 microns, the measurement module 122 may be able to measure the displacement of the build platform to an accuracy of about +/−4 microns. In the example shown in FIG. 1, the measurement module 122 is shown attached to the underside of the build platform 110. In other examples, the measurement module 122 may be placed at any suitable location to enable the displacement of the build platform 122 to be accurately determined.

In one example, as illustrated in FIG. 2, the measurement module 122 may comprise an optical encoder 122A coupled to the underside of the build platform 110. The optical encoder 122A may comprise, for example, an optical sensor, and a light source. The optical sensor may, for example, generate an electrical signal based on an amount of light received from the light source that is reflected off an encoder strip

Additionally, fixed to, or incorporated into, or otherwise associated with, one side of the internal volume of the build unit 112 is an encoder strip 122B. The encoder strip 122B may, for example, be an encoder strip similar to those used in printing systems to determine the position of a printing carriage along of carriage path. For example, the encoder strip 122B may comprise a set of regularly spaced visual markings on a background having a contrasting colour. In this way, as the optical encoder 122A moves over the encoder strip the transition over each of the visual markings may be detected and counted. The accuracy of such an optical encoder and encoder strip depends on the resolution of the visual markings. In one example, the encoder strip may have a resolution of four encoder units per micron, allowing a precision of 0.25 microns.

In other examples, the measuring device 122 may be any other suitable kind of measurement device, such as a laser measuring device or an ultrasonic measuring device. Such a device may, for example, be used to determine the build platform displacement by measuring a displacement of the base of the build platform, or by measuring a displacement of an upper, or an outer, surface of the build platform or a layer of build material formed thereon.

In one example, the build unit 112 may be integrated into the 3D printing system 100. In another example, the build unit 112 may be a removable element that may be inserted into the 3D printing system 100 so that a 3D object or objects may be generated in the build unit 112.

Operation of the 3D printing system 100 is generally controlled by a printer controller 126, further details of which are shown in FIG. 3.

Referring now to FIG. 3, the printer controller 126, according to one example, is shown in greater detail. The printer controller 126 comprises a processor 302, such as a microprocessor or microcontroller. The processor 302 is electronically coupled to a memory 304 via a suitable communications bus (not shown). The memory 304 stores a set of machine readable instructions that are readable and executable by the processor 302 to control the 3D printing system according to the instructions. Execution of the instructions cause a method of operating the 3D printing system 100 to be performed, as illustrated in the flow diagram of FIG. 4 and as described below.

Specifically, the memory 304 comprises platform displacement control instructions 306 that, when executed by the processor 302, cause the drive module 120 to move (block 402), for example to lower, the build platform 110 by an intended height. The memory 304 additionally comprises platform displacement determination instructions 308 that, when executed by processor 302, determine (block 404) a vertical displacement of the build platform 110. For example, the instructions may cause the processor 302 to receive electronic signals from the measurement module 122 to enable the vertical displacement of the build platform to be accurately determined. If, as described above, the measurement module 122 comprises an optical encoder 122A, the instructions may cause the processor 302 to receive electronic signals from the optical encoder 122A as the optical encoder 122A passes over optical encoder strip 122B to enable the vertical displacement of the build platform to be determined to an accuracy matching the resolution of the optical encoder strip 122B.

At block 406, the printer controller 126 controls the build material layering module 102 to form a layer of build material on the build platform 110. For example, the printer controller 126 may cause the build material layering module 102 to move from one side of the build platform 110 to the other to cause a volume of build material 108 formed on the build material supply platform 114 to be spread over the build platform 110 to form a layer thereon.

The memory 304 additionally comprises energy correction instructions 310 that, when executed by the processor 302, cause the processor to determine (block 408), based on the determined vertical displacement of the build platform 110 an amount of energy to apply (block 410) to the formed layer of build material through the energy source 104. In one example, applying a determined amount of fusing energy comprises applying a set amount of electrical power to a fusing energy source to cause the energy source to emit a related amount of energy to a layer of build material as the energy source is moved over the layer of build material at a predetermined speed.

At block 410, the printer controller 126 controls the energy source 104 to apply the determined amount of energy to the form layer of build material on the build platform 110.

It will be understood that the order in which some of the blocks described above are performed may be changed without affecting the outcome of the process. Some of the blocks may also be performed in parallel to the performance of other blocks.

Referring now to FIG. 5 there is shown a simplified illustration of a 3D printing system 500 according to one example. Some of the elements shown in FIG. 5 are similar or are equivalent features shown in FIG. 1 and are hence given the same reference numeral.

3D printing system 500 comprises a fusing module 501 having an agent distributor 502, a first energy source 504 located on one side of the agent distributor 502, and a second energy source 506 located on the other side of the agent distributor 502. The elements of the fusing module may be mounted on a carriage that is moveable over the build platform 110. The elements of the fusing module may span the width of the build platform to enable energy and printing agent to be applied to any addressable location on a formed layer of build material.

The agent distributor 502 may be a printhead, such as a thermal inkjet (TIJ) printhead, or a piezoelectric printhead. The agent distributor 502 is to print, or apply, drops of an energy absorbing fusing agent to a layer of build material in a pattern based on a 3D object model of a 3D object to be generated by the 3D printing system 500. For example, a 3D object model may be sliced into a series of parallel planes, each slice being represented by a bitmap image representing the portions of each layer of build material to be solidified by the 3D printing system 500. In one example, those portions may represent portions of a layer of build material to which a fusing agent is to be applied.

In the example shown, by applying fusing energy from one or both of the energy sources 504 and 506 causes portions of the layer of build material on which fusing agent was applied to heat up sufficiently to melt, sinter or otherwise fuse, to form a layer of the 3D object being generated. Portions of the layer of build material on which fusing agent was not applied generally will not heat up sufficiently to melt, sinter, or fuse.

In the example shown, as the fusing module 501 is moved over the build platform 110 the agent distributor 502 may selectively print fusing agent, and the trailing energy source (relative to the direction of travel of the fusing module 501) may apply a first level of energy that is to cause sufficient heating and fusing of build material on which fusing agent was applied. Is this example, the fusing energy source refers to as the energy source 504 or 506 that is trailing the agent distributor 502 as it is moved over the build platform 110.

In another example, the leading energy source (relative to the direction of travel of the fusing module) may apply a level of energy lower than the trailing energy source to warm, or pre-heat, the formed layer of build material to a temperature close to but below the melting temperature of the build material. In this example, the warming energy source refers to the energy source 504 or 506 that is leading the agent distributor 502 as it is moved over the build platform 110.

The symmetrical arrangement of the fusing module 501 allows both printing of fusing agent and application of fusing energy to occur whilst the fusing module 501 is moving bi-directionally over the build platform 110.

In another example, warming of the formed layer of build material may be accomplished using a static overhead warming energy source, such as an array of halogen lamps.

The printing system 500 is generally controlled by a printer controller 508, similar to printer controller 126 shown in FIGS. 1 and 3.

The printer controller 508 comprises machine readable instructions that, when executed by the controller 508, cause the printing system 500 to operate in accordance with the method illustrated in the flow diagram shown in FIG. 6.

At block 602, the controller 508 instructs the drive module 120 to lower the build platform 110 to lower by a predetermined height. In one example, the predetermined height may be a height of 80 microns. In one example, where the drive module 120 comprises a motor, instructing the drive module 120 may comprise sending an electrical signal to the motor for a predetermined length of time to cause rotation of a motor shaft coupled to the support member 118. In another example, instructing the drive module 120 may comprise instructing the motor, for example by sending a series of electrical pulses, to cause rotation of a motor shaft a predetermined number of times or by a predetermined angle.

At block 604, the controller 508 controls a build material layering module 102 to form a layer of build material on the build platform 110. For example, the build material layering module 102 may be moved, or scanned, over the build platform 110 to spread a volume 108 of build material deposited or formed on a build material supply platform 114. In the example shown the build material layering module 102 is shown to be moveable independently from a fusing module 501, although in other examples the recoater may be located on the same carriage as the fusing module 501.

At block 606, the controller 508 determines, using the measurement module 122, the actual displacement of the build platform.

At block 608, the controller 508 determine an amount of fusing energy to be applied to the layer of build material by the fusing energy source (504 or 506).

At block 610, the controller 508 controls the fusing module 501 to move over the build platform 110 and controls the agent distributor to selectively print or apply fusing agent based on the 3D object model of the object to be generated. At block 612, the controller 508 controls the fusing energy source (504 or 506) to apply the determined amount of energy, to cause portions of the formed layer of build material on which fusing agent was applied to heat up sufficiently to melt, sinter, or otherwise fuse.

The amount of energy to be applied for a given layer thickness may be determined through suitable experimentation. However, in one example, as illustrated in FIG. 7, the relationship between the amount of energy to be applied by the energy source 104 and the determined layer thickness is linear and be thus represented algorithmically. Data based on the relationship between layer thickness and the amount of energy to be applied may be stored in a memory accessible by the printer controller, for example, in a look-up table.

The data in FIG. 7 is based on a PA12 build material, such as PA12 build material commercially known as V1R10A “HP PA12” and a fusing agent commercially known as V1Q60Q “HP fusing agent”, both available from HP Inc.

As can be seen, a layer thickness of 70 microns may require about 3000 watts of fusing energy to cause a portion on which fusing agent has been applied to melt or sinter, whereas a layer thickness of 80 microns may require about 3200 watts of fusing energy.

The relationship between fusing power and layer thickness may vary based on, for example, any one or more of: characteristics of the build material; speed at which the fusing energy source is moved over the build platform; characteristics of the fusing agent used; the density of fusing agent applied; thermal losses during the fusing process; and the temperature to which build material is pre-heated prior to fusing.

Although the examples described above relate to determining an amount of fusing energy to apply based on a determined actual distance moved by a build platform, in some examples the same techniques may also be applied to determining an amount of warming energy to apply based on a determined actual distance moved by a build platform.

The examples described above relate to fusing agent and fusing energy based 3D printing systems. However, the same techniques may also be applied to other types of 3D printing system, such as selective laser sintering (SLS), stereolithographic (SLA), and binder jetting type 3D printing systems. For example, in an SLS system, the power applied to a sintering laser can be based on the actual distance moved by a build platform and not on the intended distance moved by the build platform. In an SLS system, the sintering laser may be controlled to selective heat, sinter, melt, or otherwise fuse portions of build material based on a 3D object model of a 3D object to be generated.

Similarly, in SLA systems, the power applied to a curing energy source, such as a laser or a digital light projector source, may also be based on the actual distance moved by a build platform, and not on the intended distance moved by the build platform.

Although reference is made throughout to the ‘height’ of a build platform, it will be understood that in other examples it may be more appropriate to refer to a displacement or distance moved by the build platform. For example, in some examples, such as with an SLA system, a build platform may be positioned in a vertical orientation in a build unit containing a liquid build material. In this example, the build platform may be move horizontally as layers of liquid build material are selectively solidified through a side of the build unit. In another example SLA system, the build platform may be positioned at the bottom of a build unit and may be raised vertically as layers of liquid build material are selectively solidified through the base of the build unit. In such a system, the active process of forming a layer of build material on the build platform may be omitted, since movement of the build platform within a build unit containing a liquid build material may cause a layer of build material to be automatically formed thereon.

It will be appreciated that examples described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A three-dimensional printing system comprising a controller to:
instruct a build platform control module to move a build platform by a predetermined distance;
determine, using a measurement module, the actual distance moved by the build platform;
control a build material layering module to form a layer of build material on the build platform; and
control an energy source to apply an amount of energy to the formed layer of build material, the amount of energy based on the determined actual distance.

2. The system of claim 1, wherein the controller is to control the energy source to cause portions of the formed layer of build material to heat up sufficiently to melt, sinter, or otherwise fuse together based on a 3D object model.

3. The system of claim 1, further comprising an agent distributor, and wherein the controller is further to control the agent distributor to selectively apply an energy absorbing fusing agent to a layer of build material based on a 3D object model of an object to be generated, and wherein the application of the amount of energy to a portion of build material on which fusing agent is applied is to cause the portion to heat up sufficiently to melt, sinter, or otherwise fuse.

4. The system of claim 1, wherein the measurement module comprises:
an optical sensor coupled to the underside of the build platform; and
an encoder strip associated with one side of the internal volume of the build unit.

5. The system of claim 1, wherein the measurement module comprises a laser sensor to determine the build platform displacement by one of: measuring a displacement of the base of the build platform; and measuring a displacement of an upper, or outer, surface of the build platform or a layer of build material previously formed thereon.

6. The system of claim 1, wherein the controller is to control a control module comprising a motor coupled to a lead screw, and wherein instructing the control module to move the build platform comprises instructing a motor shaft to make a predetermined number of rotations or to rotate by a predetermined angle.

7. The system of claim 1, further comprising an energy source to apply a generally uniform amount of energy to each layer of build material as the energy source is moved over the build platform.

8. The system of claim 1, further comprising a sintering laser, and wherein the controller is further to control the sintering laser to selective apply the amount of energy to a portion of build material to cause the portion to heat up sufficiently to melt, sinter, or otherwise fuse.

9. A method of controlling an energy source in a 3D printing system comprising:
instructing a build platform drive module to lower the build platform by an amount;
forming a layer of build material on the build platform;
determining the actual amount by which the build platform was lowered;
controlling the energy source to emit an amount of energy to the formed layer to selectively solidify portions of the formed layer, the amount of energy based on the determined actual amount by which the build platform was lowered.

10. The method of claim 9, further comprising applying an energy absorbing fusing agent on the formed layer of build material in a pattern based on a three-dimensional object model of an object to be generated.

11. The method of claim 10, further comprising controlling the energy source to apply a generally uniform amount of energy to the formed layer of build material as the energy source is moved over the build platform, the power applied to the energy source being based on the determined actual amount by which the build platform was lowered.

12. The method of claim 10, further comprising controlling a sintering laser to selective heat, sinter, melt, or otherwise fuse portions of build material based on a 3D object model of a 3D object to be generated, the power of the sintering laser being based on the actual amount moved by a build platform

13. The method of claim 9, further comprising determining the actual amount by which the build platform was lowered through use of an optical encoder coupled to the base of the build platform, and a linear encoder strip that is fixed to, incorporated into, or is otherwise associated with one side of the internal volume of the build unit.

14. A three-dimensional printing system comprising:
a layering module to form a layer of build material on a build platform in a build unit;
a fusing energy source; and
a controller to:
control the build platform to move by a predetermined distance within the build unit;
control the layering module to form a layer of build material on the build platform;
determine the thickness of the formed layer of build material; and
control the electrical power of the fusing energy source to apply an amount of energy to the formed layer of build material, the amount of energy based on the determined thickness of the formed layer of build material.

15. The system of claim 14, wherein the controller is to determine the thickness of the formed layer by determining the distance moved by the build platform.
